(19) United States
(12) Patent Application Publication
(10) Pub. No.: US 2026/0249764 A1
(43) Pub. Date: Aug. 27, 2026

(54) SAFETY HANDLE AND KIT FOR USE ON PUBLIC TRANSPORTATION, INCLUDING THE METHODS OF USE AND INSTALLATION

(71) Applicants: Carlos Guzman, Signal Hill, CA (US); John Guzman, Hunting Beach, CA (US)

(72) Inventors: Carlos Guzman, Signal Hill, CA (US); John Guzman, Hunting Beach, CA (US)

(21) Appl. No.: 19/062,555

(22) Filed: Feb. 25, 2025

(51) Int. Cl. B60N 3/02; B62D 65/14

(52) U.S. Cl. CPC B60N 3/026; B62D 65/14

(57) ABSTRACT

A safety handle kit is disclosed and includes: a rigid and fixed handle component, at least one coupling component, and at least one affixing component, and at least one affixing component, wherein when the handle component is coupled to a seat, bench or combination thereof with the use of the at least one coupling component and the at least one affixing component, it forms a safety handle that is a closed loop. Methods of installing a safety handle kit comprise: providing a rigid and fixed handle component, providing at least one coupling component, providing at least one affixing component, and coupling the handle component to a seat, bench or combination thereof through the coupling component by utilizing the at least one affixing component, wherein when the handle component is coupled to a seat, bench or combination thereof with the use of the at least one coupling component and the at least one affixing component, it forms a safety handle that is a closed loop.

This United States Continuation in Part Application claims priority to U.S. Utility application Ser. No. 14/292,848, which claims priority to U.S. Provisional Application Ser. No. 61/829,552 filed on May 31, 2013 entitled “Safety Handle and Kit for Use on Public Transportation, Including the Methods of Use and Installation”, which are commonly owned and incorporated herein in their entirety by reference.

### FIELD OF THE SUBJECT MATTER

The field of the subject matter is a safety handle and related kit for use on public transportation, including the methods of use and installation.

### BACKGROUND

Public transportation is widely used, especially in larger cities, because of the cost of gasoline and the cost of purchasing, maintaining and operating automobiles. In addition, many people are choosing public transportation, because it can be difficult, if not impossible, to find available and/or cost-effective parking in some cities. As used herein, public transportation generally refers to shuttles, buses and railway transportation, such as light rail, metro rail, trams, planes and commuter trains.

One problem in many types of public transportation currently in use is that there is no place for a seated passenger to easily grasp, if the shuttle, bus or train comes to a quick and/or unexpected stop. Many of these seats do not have seatbelts or other handles that extend up and provide a safe place to hold on to quickly. In the instance of a quick and unexpected stop, the passenger may then slide forward or sideways off of the seat resulting in injury or death to that person or another nearby passenger.

Given that there are so many trains and cars in use for public transportation, many of the currently existing cars cannot be replaced in order to be made safer but instead must be modernized and retrofitted in a manner that allows the car to remain in use, while at the same time allowing the car to be made safer. Cities cannot afford to replace all of the seats, in order to provide seat belts or handles, so they must find another solution.

It would be ideal to develop a safety handle and safety handle retrofitting kit to address the current problems, wherein the handle is in kit form, so that it can be easily and securely installed on currently used conventional public transportation. In some embodiments, newer buses, trams, shuttles and trains can be built that incorporate these contemplated safety handles, but in most conventional public transportation uses, these safety handles will need to be installed from a kit.

### SUMMARY OF THE SUBJECT MATTER

Specifically, a contemplated safety handle kit comprises: a rigid and fixed handle component, at least one coupling component, and at least one affixing component, wherein when the handle component is coupled to a seat, bench or combination thereof with the use of the at least one coupling component and the at least one affixing component, it forms a safety handle that is a closed loop.

Methods of installing a safety handle kit comprise: providing a rigid and fixed handle component, providing at least one coupling component, providing at least one affixing component, and coupling the handle component to a seat, bench or combination thereof through the coupling component by utilizing the at least one affixing component, wherein when the handle component is coupled to a seat, bench or combination thereof with the use of the at least one coupling component and the at least one affixing component, it forms a safety handle that is a closed loop.

### BRIEF DESCRIPTION OF THE FIGURES

FIG. 1 shows a safety handle kit 100 with one set of contemplated component parts, including a rigid and fixed handle component 110, at least one coupling component 120 and a set of affixing components 130, which in this embodiment comprise a set of nuts 134 and bolts 136 that are designed to secure the handle component 110 in place through the at least one coupling component 120.

FIG. 2 shows a safety handle kit 200 after installation onto a seat, bench or combination thereof 205, including a rigid and fixed handle component 210, at least one coupling component 220 and a set of affixing components 230, which in this embodiment comprise a set of nuts 234 and bolts 236 that are designed to secure the handle component 210 in place through the at least one coupling component 220. In this Figure, the “closed loop” 240 is clearly shown, despite the fact that the handle component pre-installation is not a closed loop. It forms the closed loop when coupled with the seat, bench or combination thereof 205.

Contemplated methods of installing a safety handle kit 300 are shown in FIG. 3 comprises: providing 310 a rigid and fixed handle component, providing 320 at least one coupling component, providing 330 at least one affixing component, coupling 340 the handle component to a seat, bench or combination thereof through the coupling component by utilizing the at least one affixing component, wherein when the handle component is coupled to a seat, bench or combination thereof with the use of the at least one coupling component and the at least one affixing component, it forms 350 a safety handle that is a closed loop.

FIG. 4 shows a safety handle kit 400 with one set of contemplated component parts, including a rigid and fixed handle component 410, at least one coupling component 420 and a set of affixing components 430, which in this embodiment comprise a set of nuts 434 and bolts 436 that are designed to secure the handle component 410 in place through the at least one coupling component 420.

FIG. 5 shows a safety handle kit 500 with one set of contemplated component parts, including a rigid and fixed handle component 510, at least one coupling component 520 and a set of affixing components (not shown), where this embodiment shows a closed loop handle component 510 according to one contemplated embodiment.

FIG. 6 shows a method 600 of installing a safety handle kit comprise: providing 600 a rigid and fixed handle component, providing 610 at least one coupling component, providing 620 at least one affixing component, and physically coupling the handle component to a seat portion of a seat, bench or combination thereof through the coupling component by utilizing the at least one affixing component, wherein when the handle component is coupled to the seat portion of a seat, bench or combination thereof with the use of the at least one coupling component and the at least one affixing component, it forms a safety handle that is a closed loop. In this embodiment, the handle component is directly attached, coupled, or a combination thereof to the seat, bench or combination thereof through and by using the coupling component.

FIG. 7 shows a method 700 of installing a safety handle kit comprise: providing 700 a rigid and fixed handle component, providing 710 at least one coupling component, providing 720 at least one affixing component, and physically coupling 730 the handle component to a seat portion of a seat, bench or combination thereof through the coupling component by utilizing the at least one affixing component, wherein when the handle component is coupled to the seat portion of a seat, bench or combination thereof with the use of the at least one coupling component and the at least one affixing component, it forms a safety handle that is a closed loop. In this embodiment, the handle component is directly attached, coupled, or a combination thereof to the seat, bench or combination thereof through and by using the coupling component.

### DETAILED DESCRIPTION

A safety handle has been developed to address the current problems, wherein the handle is in kit form, so that it can be easily and securely installed on seats and benches in currently used conventional public transportation. In some embodiments, newer buses, trams, shuttles and trains can be built that incorporate these contemplated safety handles, but in most conventional public transportation uses, these safety handles will need to be installed from a kit.

Specifically, a contemplated safety handle kit comprises: a rigid and fixed handle component, at least one coupling component, and at least one affixing component, wherein when the handle component is coupled to a seat, bench or combination thereof with the use of the at least one coupling component and the at least one affixing component, it forms a safety handle that is a closed loop.

Contemplated safety handle kit components may be constructed of any suitable material, including steel, composite material or combinations thereof. It should be understood that material that is not suitable for use as a safety handle in emergency situations is not contemplated. The material for contemplated handle components and coupling components may be hollow, such as a pipe or may be solid throughout, as long as it is suitable to be a material for use as a safety handle, in that it is strong, secure and not easily bent or deformed. As used herein, the phrase “rigid and fixed” with respect to the handle component means that the handle component is not easily deformed or bent and is fixed in its shape, such that it forms a closed loop either before or after installation.

Contemplated coupling components may be a natural extension of the handle component or may be something that is affixed to the handle component by the at least one affixing component or another suitable component that can couple the handle component to the coupling components. But, in many contemplated embodiments, the handle component and the coupling component or components are one seamless entity, which helps to maintain the strength and durability requirements of contemplated safety handles.

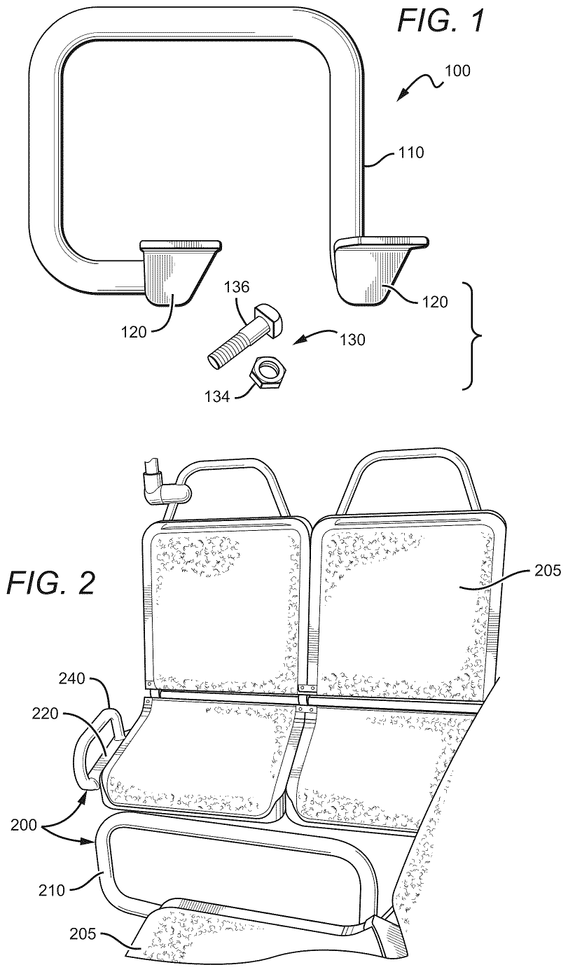

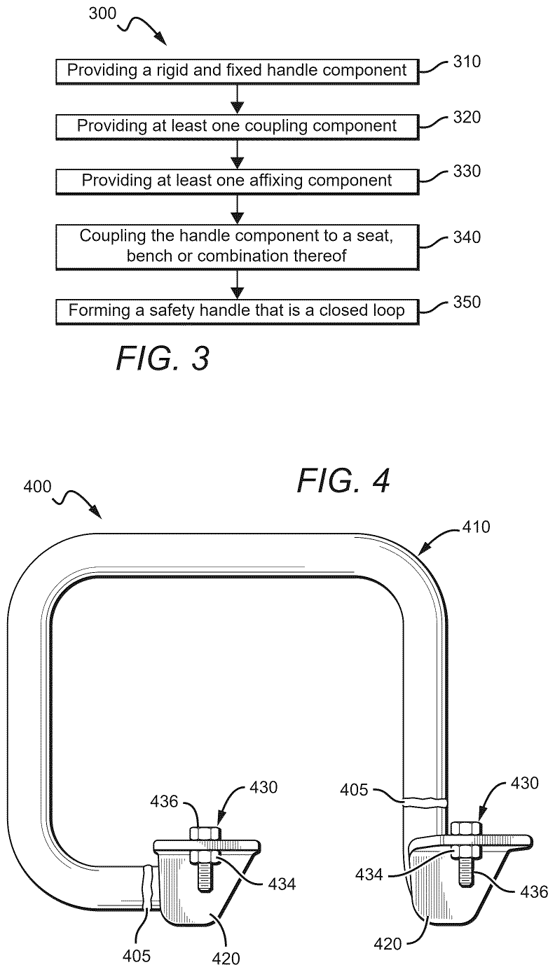

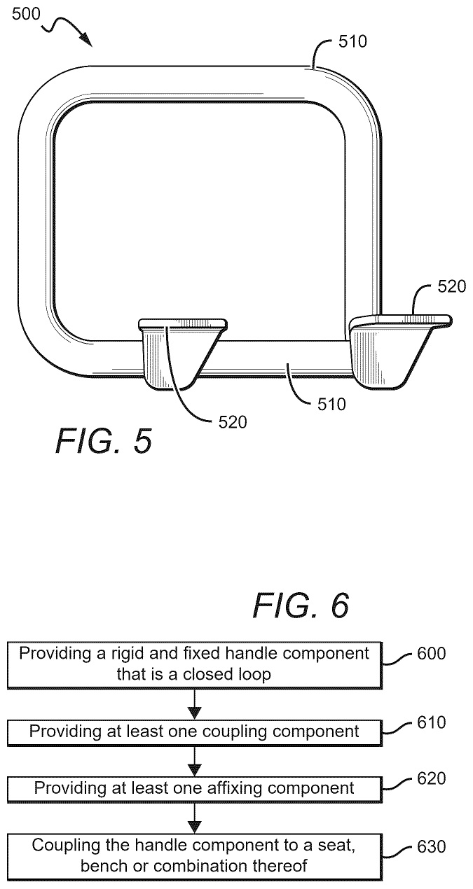

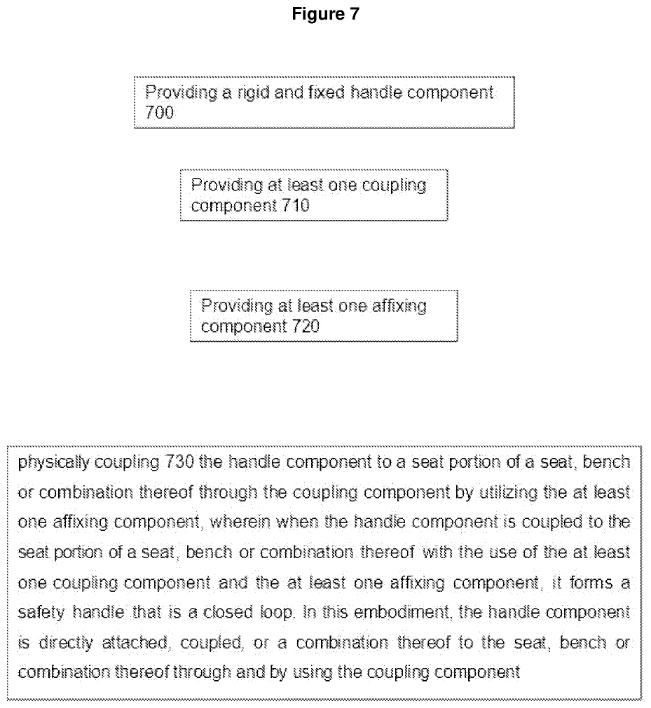

As used herein, the phrase “a closed loop” means that the safety handle does not have an open end when it is installed on a seat, bench or combination thereof. The safety handle component may not be a closed loop before installation, such as the one shown in FIG. 1, but after installation, a portion of the seat, bench or combination thereof closes the loop of the safety handle, as shown in FIG. 2.

FIG. 1 shows a safety handle kit 100 with one set of contemplated component parts, including a rigid and fixed handle component 110, at least one coupling component 120 and a set of affixing components 130, which in this embodiment comprise a set of nuts 134 and bolts 136 that are designed to secure the handle component 110 in place through the at least one coupling component 120.

FIG. 2 shows a safety handle kit 200 after installation onto a seat, bench or combination thereof 205, including a rigid and fixed handle component 210, at least one coupling component 220 and a set of affixing components 230, which in this embodiment comprise a set of nuts 234 and bolts 236 that are designed to secure the handle component 210 in place through the at least one coupling component 220. In this Figure, the “closed loop” 240 is clearly shown, despite the fact that the handle component pre-installation is not a closed loop. It forms the closed loop when coupled with the seat, bench or combination thereof 205. In addition, contemplated safety handles that have a closed loop design are designed so that if your hand slips, it does not lose grip with the end of the handle, such as what might happen with a conventional bus or train handle.

Contemplated methods of installing a safety handle kit 300 are shown in FIG. 3 comprises: providing 310 a rigid and fixed handle component, providing 320 at least one coupling component, providing 330 at least one affixing component, and coupling 340 the handle component to a seat, bench or combination thereof through the coupling component by utilizing the at least one affixing component, wherein when the handle component is coupled to a seat, bench or combination thereof with the use of the at least one coupling component and the at least one affixing component, it forms 350 a safety handle that is a closed loop.

FIG. 4 shows a safety handle kit 400 with one set of contemplated component parts, including a rigid and fixed handle component 410, at least one coupling component 420 and a set of affixing components 430, which in this embodiment comprise a set of nuts 434 and bolts 436 that are designed to secure the handle component 410 in place through the at least one coupling component 420. In this embodiment, the at least one coupling component 420 is coupled with the handle component 410 through a spot weld 405.

FIG. 5 shows a safety handle kit 500 with one set of contemplated component parts, including a rigid and fixed handle component 510, at least one coupling component 520 and a set of affixing components (not shown), where this embodiment shows a closed loop handle component 510 according to one contemplated embodiment.

FIGS. 6 and 7 show a method 600 and 700 of installing a safety handle kit comprise: providing 600 or 700 a rigid and fixed handle component, providing 610 or 710 at least one coupling component, providing 620 or 720 at least one affixing component, and physically coupling 630 or 730 the handle component to a seat portion of a seat, bench or combination thereof through the coupling component by utilizing the at least one affixing component, wherein when the handle component is coupled to the seat portion of a seat, bench or combination thereof with the use of the at least one coupling component and the at least one affixing component, it forms a safety handle that is a closed loop. In this embodiment, the handle component is directly attached, coupled, or a combination thereof to the seat, bench or combination thereof through and by using the coupling component.

As used herein, “a seat portion” of a seat, bench or combination thereof means the portion of the seat where a person puts his or her rear end, bottom, and/or behind portion of their body. A contemplated seat portion of a seat is not the place for the back and spine area or head and neck area of a user. In other words, it is that portion of the seat where the user's rear end, bottom and/or behind portion of their body contacts the seat.

It is important to understand that in this embodiment shown in FIG. 5, the handle component forms a closed loop on its own before being attached, coupled, or a combination thereof with the seat portion of the seat, bench, or combination thereof.

In some embodiments, the at least one coupling component and the at least one affixing component are directly attached only to a seat portion of a seat, bench or combination thereof and no other portion or part of the seat; and wherein the handle component is directly attached to the seat, the bench or the combination thereof through the at least one coupling component, and wherein the handle component in combination with the at least one coupling component, the at least one affixing component, and the seat, bench or combination thereof forms a safety handle that is strong and secure for a seated passenger seated on the seat portion of the seat or bench.

It should be understood that a contemplated coupling component may be attached to a handle component or may be formed or generated as part of or as a natural extension of the handle component. In other words, the coupling component may not be able to be separated from the handle component, because it is formed as an extension of the handle component originally.

Contemplated safety handles may be constructed of any suitable material, including steel, composite material or combinations thereof. It should be understood that material that is not suitable for use as a safety handle in emergency situations is not contemplated. The material may be hollow, such as a pipe or may be solid throughout, as long as it is suitable to be a material for use as a safety handle, in that it is strong, secure and not easily bent or deformed.

As mentioned, the safety handle is meant to be installed directly on the seat, and not on a bulkhead or another part of the transportation apparatus. In addition, once the safety handles are installed, they are designed to be stationary and not retractable, such as those handles found on an airplane seat. Contemplated safety handles and handle components are installed by using the at least one affixing component to couple the coupling component of the handle component to the seat, bench or combination thereof. The at least one affixing component may comprise any suitable component or components that are designed to removably or nonremovably secure one thing to another, such as a set of nuts and bolts, a spot weld, a clamp system, or any other suitable affixing component.

Thus, specific embodiments, methods of a safety handle and related kit for use on public transportation, including the methods of use and installation have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A safety handle kit, comprising:
a rigid and fixed handle component, wherein the handle component comprises a pipe material that is hollow or a solid material, wherein the material is a solid surface, and wherein the handle component forms one single solid and closed loop;
at least one coupling component comprising at least one hole or opening, wherein the at least one coupling component is physically attached to the rigid and fixed handle component;
and at least one affixing component, wherein the at least one coupling component and the at least one affixing component are directly attached to a seat portion of a seat, bench or combination thereof; and wherein the handle component is directly attached to the seat, the bench or the combination thereof through the at least one coupling component, and wherein the handle component in combination with the at least one coupling component, the at least one affixing component, and the seat, bench or combination thereof forms a safety handle that is strong and secure for a seated passenger seated on the seat portion of the seat or bench.

2. The safety handle kit of claim 1, wherein the rigid and fixed handle component comprises metal.

3. The safety handle kit of claim 1, wherein the at least one coupling component is seamlessly coupled with the rigid and fixed handle component.

4. The safety handle kit of claim 1, wherein the at least one affixing component comprises nuts and bolts, spot welds or a combination thereof.

5. A method of installing a safety handle kit, comprising:
providing a rigid and fixed handle component, wherein the handle component comprises a pipe material that is hollow or a solid material, wherein the material is a solid surface, and wherein the handle component forms one single solid and closed loop;
providing at least one coupling component comprising at least one hole or opening, wherein the at least one coupling component is physically attached to the rigid and fixed handle component,
providing at least one affixing component, and
directly attaching the at least one coupling component and the at least one affixing component to a seat portion of a seat, bench or combination thereof; wherein the handle component is directly attached, coupled or a combination thereof to the seat, the bench or the combination thereof through the at least one coupling component, and wherein the handle component in combination with the at least one coupling component, the at least one affixing component, and the seat portion of the seat, bench or combination thereof forms a safety handle that is strong and secure for a seated passenger seated on the seat portion of the seat or bench.

6. The method of claim 5, wherein the rigid and fixed handle component comprises metal.

7. The method of claim 5, wherein the at least one coupling component is seamlessly coupled with the rigid and fixed handle component.

8. The method of claim 5, wherein the at least one affixing component comprises nuts and bolts, spot welds or a combination thereof.
